(19) United States
(12) Patent Application Publication
(10) Pub. No.: US 2025/0145372 A1
(43) Pub. Date: May 8, 2025

(54) AUTOMATIC TRANSPORT DEVICE

(71) Applicant: SHARP KABUSHIKI KAISHA, Osaka (JP)

(72) Inventor: ATSUSHI NAKAMOTO, Osaka (JP)

(21) Appl. No.: 18/913,114

(22) Filed: Oct. 11, 2024

(30) Foreign Application Priority Data
Nov. 8, 2023 (JP) 2023-190817

(51) Int. Cl. B65G 1/04

(52) U.S. Cl. CPC B65G 1/0435

(57) ABSTRACT

An automatic transport device includes: a holder including a slide surface and slidably holding an object to be transported on the slide surface; a binder binding to a side surface of the object to be transported, the binder including a sucker that adheres to a central portion on the side surface of the object to be transported, and contact members that abut on the right and left sides of the side surface; a driving motor sliding the object to be transported on the slide surface in a state where the binder is binding to the side surface of the object to be transported; and a driver enabling the automatic transport device to travel.

### INCORPORATION BY REFERENCE

This application is based upon and claims the benefit of priority from the corresponding Japanese Patent Application No. 2023-190817 filed on Nov. 8, 2023, the entire contents of which are incorporated herein by reference.

### BACKGROUND

The present disclosure relates to an automatic transport device transporting an object to be transported.

Automatic transport devices that take articles (objects to be transported) off storage shelves and transport same to predetermined positions (such as shipping areas) in warehouses or the like have been heretofore known. For example, a technique in which a sucker provided on an arm of an automatic transport device adheres to the underside of an object to be transported and thus holds and transports the object to be transported has been known.

However, in heretofore known techniques, since the sucker needs to be accurately inserted into a space below the underside of an object to be transported, high alignment accuracy is required, resulting in a problem of complication of the structure.

### SUMMARY

An object of the present disclosure is to provide an automatic transport device capable of stably holding an object to be transported with a simple structure.

An automatic transport device according to one aspect of the present disclosure is a device that transports an object to be transported to a predetermined location. The automatic transport device includes: a holder including a slide surface and slidably holding the object to be transported on the slide surface; a binder binding to a side surface of the object to be transported, the binder including a sucker that adheres to a first position on the side surface of the object to be transported, and a contact member that abuts on a second position on the side surface; a slide driver sliding the object to be transported on the slide surface in a state where the binder is binding to the side surface of the object to be transported; and a driver enabling the automatic transport device to travel.

According to the present disclosure, an automatic transport device capable of stably holding an object to be transported with a simple structure can be provided.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a side view illustrating an entire configuration of an automatic transport device according to an embodiment of the present disclosure.

FIG. 2 is a front view illustrating the entire configuration of the automatic transport device according to the embodiment of the present disclosure.

FIG. 3 is a view illustrating the automatic transport device according to the embodiment of the present disclosure and a storage shelf.

FIGS. 4A to 4D are a view illustrating an example of a picking method executed in the automatic transport device according to the embodiment of the present disclosure.

FIG. 5 is a top view illustrating a configuration of a transfer device according to the embodiment of the present disclosure.

FIG. 6 is a side view illustrating the configuration of the transfer device according to the embodiment of the present disclosure.

FIG. 7 is a view illustrating a picking method in the transfer device according to the embodiment of the present disclosure.

FIG. 8 is a view illustrating the picking method in the transfer device according to the embodiment of the present disclosure.

FIG. 9 is a view illustrating another mode of the automatic transport device according to the embodiment of the present disclosure.

FIG. 10 is a view illustrating yet another mode of the automatic transport device according to the embodiment of the present disclosure.

FIG. 11 is a view illustrating a configuration of a storage shelf according to the embodiment of the present disclosure.

FIG. 12 is a view illustrating yet another mode of the automatic transport device according to the embodiment of the present disclosure.

FIG. 13 is a view illustrating yet another mode of the automatic transport device according to the embodiment of the present disclosure.

### DETAILED DESCRIPTION

Hereinafter, an embodiment of the present disclosure will be described with reference to the accompanying drawings to provide understanding of the present disclosure. Note that the following embodiment is merely an embodied example of the present disclosure, and does not limit the technical scope of the present disclosure.

### Automatic Transport Device 1

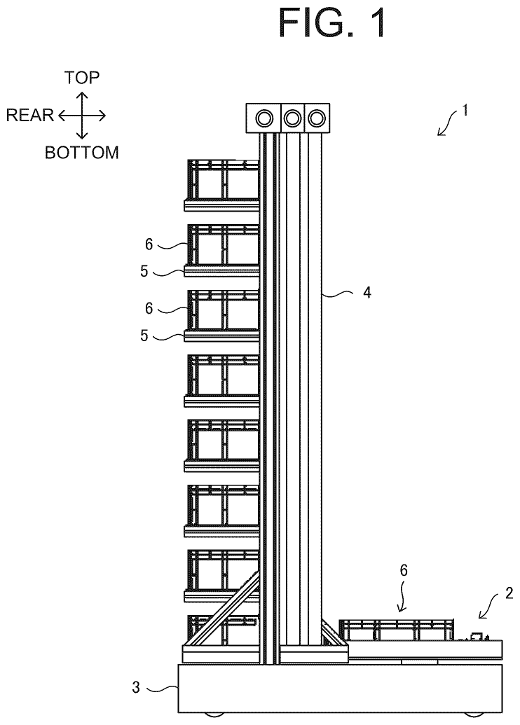

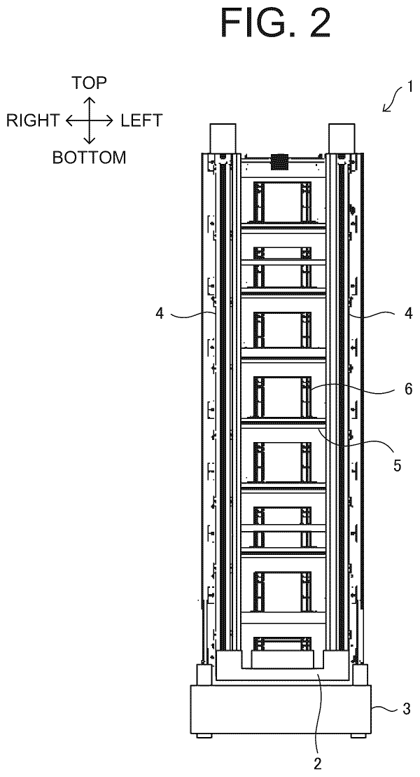

FIG. 1 is a side view illustrating an entire configuration of an automatic transport device 1 according to an embodiment of the present disclosure, and FIG. 2 is a front view illustrating the entire configuration of the automatic transport device 1. The automatic transport device 1 is, for example, an automatic guided vehicle that can travel in unmanned operation and is configured to include a driver 3, a stock shelf 5 that stocks an object 6 to be transported, and a transfer device 2 that loads and unloads the object 6 to be transported into and from the stock shelf 5.

The stock shelf 5 is an accommodation shelf capable of accommodating objects to be transported by the automatic transport device 1. For example, the stock shelf 5 is placed on and fixed to the top portion of the driver 3.

The driver 3 is configured to be capable of forward traveling, reverse traveling, and turning traveling. The driver 3 enables the automatic transport device 1 to travel along a traveling route from a current position to a target position (a storage shelf or the like) on the basis of a transport request received by a server (not illustrated), for example. The automatic transport device 1 autonomously travels along a preliminarily set traveling route on the basis of the transport request, picks the object 6 to be transported from a storage shelf, and transports the object 6 to be transported to a target position (a shipping area or the like). A traveling method of the automatic transport device 1 is not particularly limited, and a traveling method such as guide traveling in which the automatic transport device 1 travels while detecting magnetic tape placed on a floor surface, and guideless traveling in which the automatic transport device 1 travels along a traveling route while estimating the self-position can be applied.

The top portion of the driver 3 is provided with the stock shelf 5 and the transfer device 2 movable in a vertical direction. Specifically, a lifting and lowering device 4 is provided on a top panel of the driver 3, and the lifting and lowering device 4 can move the transfer device 2 to a predetermined height by controlling the lifting and lowering. Although illustration is omitted, the lifting and lowering device 4 includes a lifting and lowering rail, a lifting and lowering motor, and the like. When the transport request for transporting the object 6 to be transported is acquired, the lifting and lowering device 4 moves (lifts or lowers) the transfer device 2 to the height of the storage shelf in which the object 6 to be transported is stored.

The transfer device 2 picks the target object 6 to be transported from the storage shelf in which the object 6 to be transported is stored, and stocks (moves) the object 6 to be transported on (onto) the stock shelf 5. The stock shelf 5 is provided adjacent to the transfer device 2.

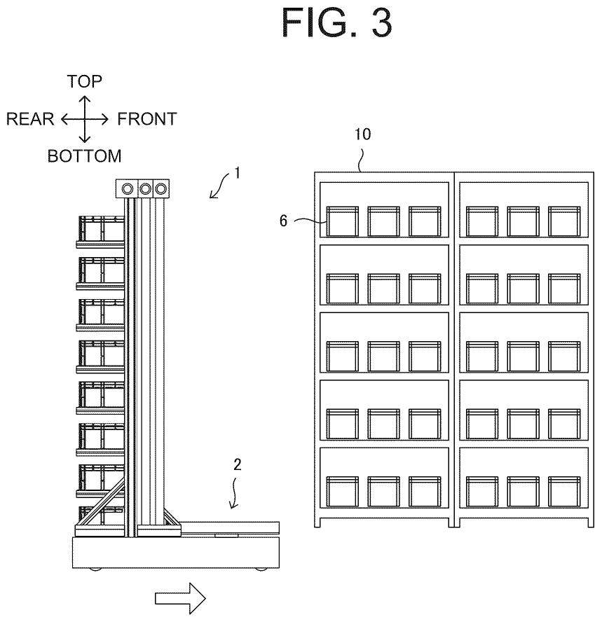

Here, an example of a procedure for moving the object 6 to be transported onto the stock shelf 5 will be described. FIG. 3 shows a storage shelf 10 in which the object 6 to be transported is stored. Upon acquiring the transport request (picking command) for transporting the object 6 to be transported, the automatic transport device 1 automatically travels to the front of the storage shelf 10 in which the object 6 to be transported is stored, according to a preliminarily set traveling route.

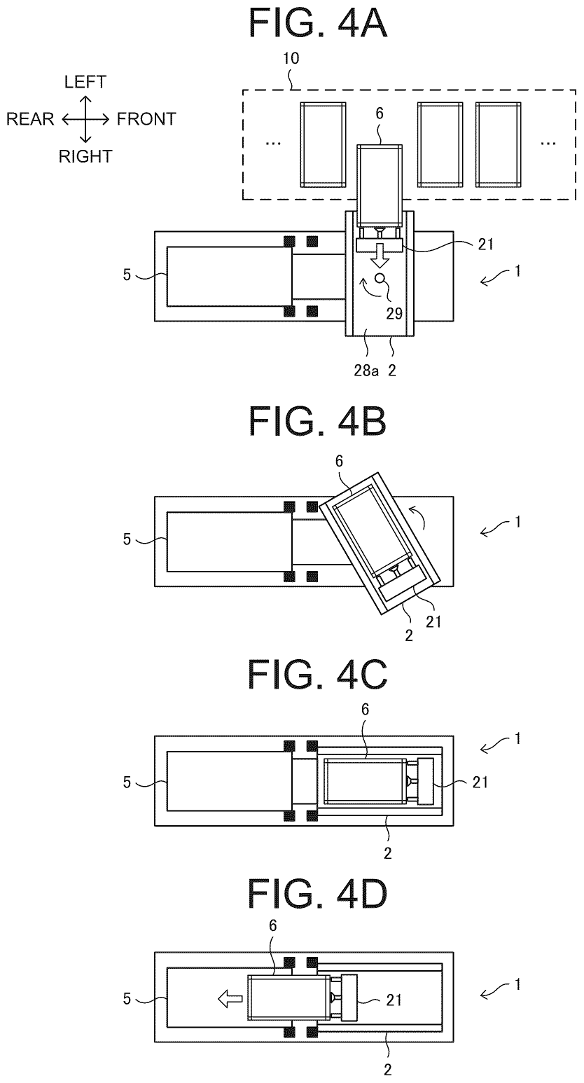

FIGS. 4A to 4D schematically illustrate a procedure in which the transfer device 2 picks the object 6 to be transported from the storage shelf 10 and moves the object 6 to be transported onto the stock shelf 5 as viewed from above. First, when the automatic transport device 1 arrives in front of the storage shelf 10 and stops, the transfer device 2 moves (lifts or lowers) to the position of the shelf in which the target object 6 to be transported is stored in accordance with an instruction of the lifting and lowering device 4. The lifting and lowering device 4 acquires position information pertaining to the object 6 to be transported on the basis of identification information on the object 6 to be transported included in the transport request, and moves the transfer device 2 to the target position on the basis of the position information.

When the transfer device 2 arrives at the target position (height), the transfer device 2 rotates in a predetermined direction (for example, the clockwise direction) about a rotation shaft 29 (see FIG. 6). For example, when the automatic transport device 1 is positioned alongside the storage shelf 10 and stops, as shown in FIG. 4A, the transfer device 2 rotates clockwise by 90 degrees about the rotation shaft 29.

Thereafter, the transfer device 2 moves a binder 21 in the direction toward the storage shelf 10 (the left direction in FIGS. 4A to 4D) to bind the binder 21 to a side surface of the object 6 to be transported. A specific binding method will be described later. When the binder 21 binds to the side surface of the object 6 to be transported, the transfer device 2 moves the binder 21 in the direction opposite to the storage shelf 10 (the right direction in FIGS. 4A to 4D), thereby sliding the object 6 to be transported on a slide surface 28a of the transfer device 2 and placing the object 6 to be transported on the slide surface 28a (FIG. 4B).

Thereafter, the transfer device 2 rotates about the rotation shaft 29 in a predetermined direction (counterclockwise) by 90 degrees FIGS. 4B to 4C). Thereafter, the transfer device 2 moves (lifts or lowers) to the target stock position (empty space) of the stock shelf 5 in accordance with an instruction of the lifting and lowering device 4. When the transfer device 2 arrives at the target position (height), the transfer device 2 moves the binder 21 in the direction toward the stock shelf 5 (the rearward direction in FIGS. 4A to 4D), thereby sliding the object 6 to be transported on the slide surface 28a and pushing the object 6 to be transported into the stock shelf 5 (see FIG. 4D). In this way, the transfer device 2 picks the object 6 to be transported from the storage shelf 10 and moves the object 6 to be transported onto the stock shelf 5.

When the transfer device 2 picks the object 6 to be transported stocked on the stock shelf 5, the transfer device 2 performs the reverse operation of the above-described procedure.

### Transfer Device 2

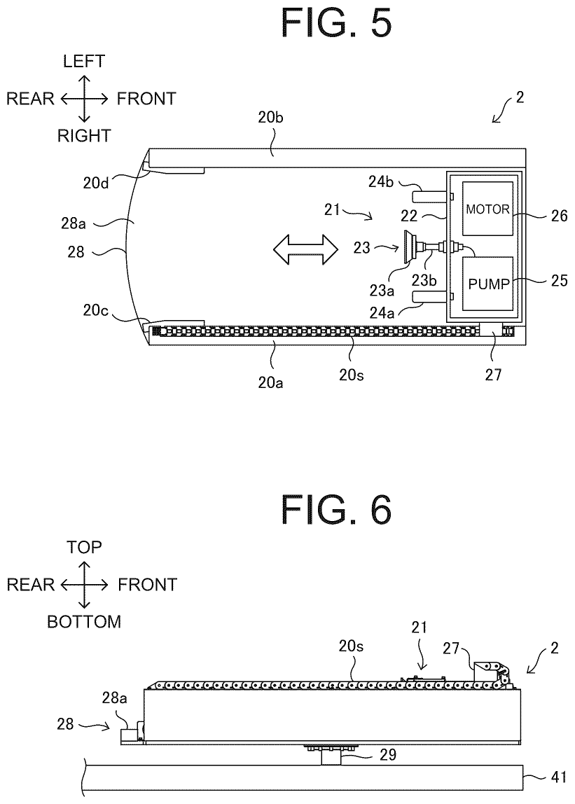

A specific configuration of the transfer device 2 that picks the object 6 to be transported will be described. FIG. 5 illustrates a top view of the transfer device 2, and FIG. 6 illustrates a side view of the transfer device 2.

The transfer device 2 includes a holder 28 (bottom plate), side walls 20a and 20b rising upward from the holder 28, the binder 21, a driving motor 26, a vacuum pump 25, and the rotation shaft 29 rotatably supporting the transfer device 2 with respect to a base 41. The base 41 is a constituent member of the lifting and lowering device 4 and is provided to be movable in the vertical direction by means of the lifting and lowering device 4.

The holder 28 includes the slide surface 28a. The holder 28 holds the object 6 to be transported so that the object 6 to be transported can slide in a front-rear direction on the slide surface 28a. The slide surface 28a may be composed of a plurality of roller members, or may be composed of a board member made of a material (resin or the like) enabling an article to slide thereon.

The side wall 20a is provided at a right end of the transfer device 2, and the side wall 20b is provided at a left end of the transfer device 2. A space in which the object 6 to be transported can be loaded and unloaded is formed between the side wall 20a and the side wall 20b. In addition, guides 20c and 20d serving as guide members when the object 6 to be transported enters the space are provided at rear ends of the side walls 20a and 20b, respectively. The side walls 20a and 20b are examples of the first side wall and the second side wall of the present disclosure.

The binder 21 binds to a side surface of the object 6 to be transported. The binder 21 includes a main body frame 22, a sucker 23, a contact member 24, the vacuum pump 25, and the driving motor 26. The binder 21 is configured to be movable in the front-rear direction above the holder 28 by driving the driving motor 26. For example, the binder 21 is moved rearward (see FIG. 5) in the transfer device 2 by rotary driving the driving motor 26 in a first direction to drive a driver (not shown) including a pulley, a wheel, a belt, or the like, and is moved forward (see FIG. 5) in the transfer device 2 by rotary driving the driving motor 26 in a second direction to drive the driver. The driving motor 26 is an example of the slide driver of the present disclosure.

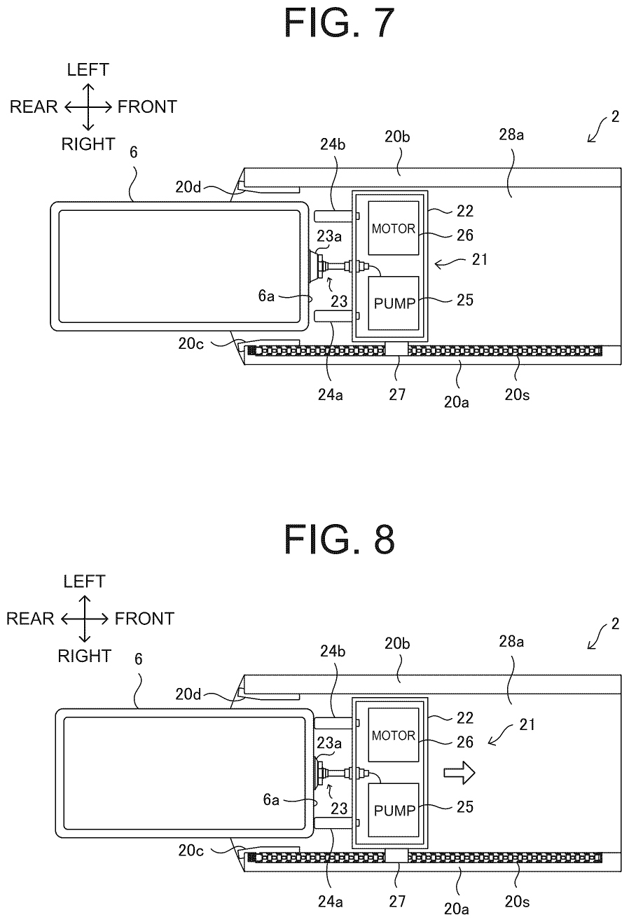

The sucker 23 adheres to the first position (for example, the central portion) on a side surface 6a (see FIG. 7) of the object 6 to be transported. Specifically, the sucker 23 includes a suction disc 23a and a shaft 23b, and is fixed to the main body frame 22. For example, the shaft 23b penetrates a side wall of the main body frame 22 and is provided to be movable in the front-rear direction. The suction disc 23a is provided at a tip of the shaft 23b, and has an expandable and contractible bellows structure. That is, the sucker 23 is provided so that the suction disc 23a side protrudes from the main body frame 22. A space is formed inside each of the suction disc 23a and the shaft 23b, and air in the internal spaces is sucked and discharged by the vacuum pump 25. Consequently, for example, when the vacuum pump 25 is driven, air in the suction disc 23a is sucked, so that the suction disc 23a adheres to the object (the object 6 to be transported).

The contact member 24 is fixed to the main body frame 22. In the present embodiment, a right contact member 24a and a left contact member 24b are exemplified, but the number of the contact members 24 is not limited and may be one or three or more. For example, the sucker 23 is provided at a central portion of the main body frame 22, the contact member 24a is provided on the right side of the main body frame 22, and the contact member 24b is provided on the left side of the main body frame 22. One end of each of the contact members 24a and 24b is fixed to the main body frame 22, and the other ends thereof protrude from the main body frame 22. The contact members 24a and 24b have the same length (protruding length). Further, as shown in FIG. 5, in a state where the sucker 23 does not adhere to the object 6 to be transported, the protruding length of the sucker 23 is longer than the protruding length of the contact members 24a and 24b. That is, in a state where the sucker 23 does not adhere to the object 6 to be transported, the sucker 23 protrudes further to the rear side (see FIG. 5) than the contact members 24a and 24b. A cushioning material (rubber or the like) may be provided at the tips of the contact members 24a and 24b so as not to be damaged when coming into contact with the object 6 to be transported.

A signal cable 20s is connected to the binder 21 via a connector 27. The signal cable 20s is composed of a flexible cable and is deformable in response to the movement of the binder 21. The signal cable 20s is connected to the driving motor 26 and the vacuum pump 25, and a control signal is sent to the driving motor 26 and the vacuum pump 25.

The rotation shaft 29 (see FIG. 6) provided on the bottom surface of the transfer device 2 is connected to the base 41, and the base 41 lifts and lowers in accordance with an instruction of the lifting and lowering device 4. The transfer device 2 moves in the vertical direction along with the lifting and lowering operation of the base 41, and also rotary moves in a horizontal direction about the rotation shaft 29 on the base 41.

In this manner, in the transfer device 2, the side walls 20a and 20b are provided at both ends of the slide surface 28a in a direction orthogonal to the sliding direction, and the binder 21 moves in the front-rear direction (the direction of the arrow in FIG. 5) between the side walls 20a and 20b in a state where the object 6 to be transported is adhered. In addition, the driving motor 26 slides the object 6 to be transported on the slide surface 28a in a state where the binder 21 binds to the side surface of the object 6 to be transported. In addition, the binder 21 includes the main body frame 22 that is slid by the driving motor 26, and the sucker 23 and the contact member 24 are provided so as to protrude from the main body frame 22.

### Picking Method

A specific example of a method of picking the object 6 to be transported by the transfer device 2 will be described with reference to FIG. 7 and FIG. 8. Here, an example in which the transfer device 2 picks the object 6 to be transported and moves the object 6 to be transported onto the slide surface 28a of the holder 28 is illustrated.

First, when the transfer device 2 arrives at the position of the target object 6 to be transported, the binder 21 is moved rearward to the position of the object 6 to be transported by driving the driving motor 26. When the binder 21 moves and the suction disc 23a of the sucker 23 comes into contact with the side surface 6a of the object 6 to be transported, the vacuum pump 25 is driven. Consequently, air in the suction disc 23a is sucked, so that the suction disc 23a adheres to the side surface 6a (see FIG. 7). Then, the vacuum pump 25 is further driven to further suck air in the suction disc 23a. Consequently, the suction disc 23a contracts, the object 6 to be transported moves forward or the binder 21 moves rearward along with deformation of the suction disc 23a, and the contact members 24a and 24b come into contact with the side surface 6a of the object 6 to be transported (see FIG. 8).

In this manner, in the state before the sucker 23 adheres to the object 6 to be transported, the protruding length from the main body frame 22 of the sucker 23 is longer than those of the contact members 24a and 24b. For this reason, the sucker 23 adheres to the object 6 to be transported, and the protruding length of the sucker 23 becomes equal to the protruding lengths of the contact members 24a and 24b, so that the contact members 24a and 24b abut on the side surface 6a of the object 6 to be transported.

In the above configuration, the object 6 to be transported is held, through the suction operation of the vacuum pump 25, at three points, the sucker 23 and the contact members 24a and 24b.

After the sucker 23 adheres to the object 6 to be transported, the transfer device 2 moves the binder 21 in the direction toward the inside of the holder 28 (toward the front in FIG. 8) by driving the driving motor 26. Consequently, the object 6 to be transported is pulled by the binder 21 and slides forward on the slide surface 28a.

Incidentally, only suction force of the sucker 23 may act on the object 6 to be transported while the binder 21 pulls the object 6 to be transported. That is, the contact members 24a and 24b may be moved away from the side surface 6a of the object 6 to be transported by slightly moving the shaft 23b of the sucker 23 rearward when the binder 21 pulls the object 6 to be transported. In this case, the object 6 to be transported is pulled and slid by the sucker 23 in a state where a gap is formed between the object 6 to be transported and the contact members 24a and 24b. When the left and right balance of the object 6 to be transported is disturbed during the sliding movement, and the object 6 to be transported is oriented obliquely, the contact members 24a and 24b abut on the side surface 6a of the object 6 to be transported. Consequently, the posture of the object 6 to be transported is regulated, the object 6 to be transported can thus be moved substantially straight.

As another embodiment, the position of the sucker 23 in the front-rear direction with respect to the main body frame 22 and the suction force of the vacuum pump 25 may be adjusted so that the suction force of the sucker 23 and the pressing force of the contact members 24a and 24b act on the object 6 to be transported while the binder 21 pulls the object 6 to be transported.

As described above, the binder 21 is provided to be movable with respect to the slide surface 28a in the first direction which is the protruding direction of the sucker 23 and the second direction opposite to the first direction. In addition, the binder 21 moves in the first direction which is the direction toward the storage (storage shelf 10 or stock shelf 5) in which the object 6 to be transported is stored, and after the sucker 23 adheres to the object 6 to be transported in the storage, and after the contact members 24a and 24b abut on the object 6 to be transported, the binder 21 moves in the second direction together with the object 6 to be transported, thereby placing the object 6 to be transported on the slide surface 28a.

According to the above configuration, the object 6 to be transported can be picked by the sucker 23 and moved onto the slide surface 28a of the holder 28.

When the object 6 to be transported placed on the slide surface 28a is moved to the storage, the binder 21 performs an operation to push out the object 6 to be transported rearward.

For example, the binder 21 moves rearward by driving the driving motor 26 in a state where the sucker 23 adheres to the side surface 6a of the object 6 to be transported. The object 6 to be transported is pushed out rearward along with the movement of the binder 21.

In this manner, the binder 21 moves in the first direction (protruding direction) in a state where the sucker 23 adheres to the object 6 to be transported placed on the slide surface 28a and where the contact members 24a and 24b abut on the object 6 to be transported, thereby moving the object 6 to be transported to a predetermined storage (storage shelf 10 or stock shelf 5).

Here, when the binder 21 moves to the outside (rear side in FIG. 8) of the holder 28, the contact members 24a and 24b push the side surface 6a of the object 6 to be transported. At this time, in order to prevent the sucker 23 and the connector between the sucker 23 and the main body frame 22 from being damaged due to excessive force acting thereon, it is desirable to perform adjustment so as not to apply force to the sucker 23. Here, the sucker 23 is provided to be movable in the axial direction of the sucker 23 with respect to the main body frame 22 upon receiving pressing force. Specifically, the shaft 23b of the sucker 23 is provided to be movable forward with respect to the main body frame 22 when the binder 21 pushes out the object 6 to be transported rearward. Therefore, although the pressing force acting on the contact members 24a and 24b from the object 6 to be transported increases, the pressing force acting on the sucker 23 from the object 6 to be transported decreases, while the binder 21 pushes the object 6 to be transported. In this way, by providing the sucker 23 so as to be capable of advancing and retreating with respect to the main body frame 22, damage to the sucker 23 can be prevented.

Note that the suction force applied to the sucker 23 when the binder 21 pushes the object 6 to be transported out from the slide surface 28a may be smaller than the suction force applied to the sucker 23 when the binder 21 pulls the object 6 to be transported onto the slide surface 28a.

When the object 6 to be transported is moved to the target position, the transfer device 2 drives the vacuum pump 25 to discharge air from the sucker 23, thereby separating the object 6 to be transported from the sucker 23.

As described above, the automatic transport device 1 is a device that transports the object 6 to be transported to a predetermined location. In addition, the automatic transport device 1 includes: the holder 28 including the slide surface 28a and slidably holding the object 6 to be transported on the slide surface 28a; the binder 21 binding to the side surface 6a of the object 6 to be transported, the binder 21 including the sucker 23 that adheres to the first position (central portion) on the side surface 6a of the object 6 to be transported, and the contact members 24a and 24b that abut on the second position (left and right sides) of the side surface 6a; the driving motor 26 sliding the object 6 to be transported on the slide surface 28a in a state where the binder 21 is binding to the side surface 6a of the object 6 to be transported; and the driver 3 enabling the automatic transport device 1 to travel.

According to the above configuration, the sucker 23 and the contact members 24a and 24b bind to the side surface 6a of the object 6 to be transported, and the object 6 to be transported can be slid. Therefore, the automatic transport device 1 according to the present disclosure can stably hold the object 6 to be transported with a simple structure as compared with conventional configurations.

### Other Embodiments

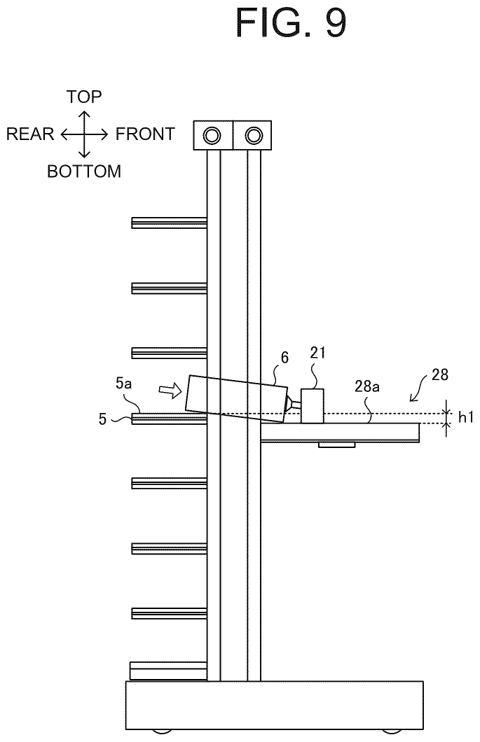

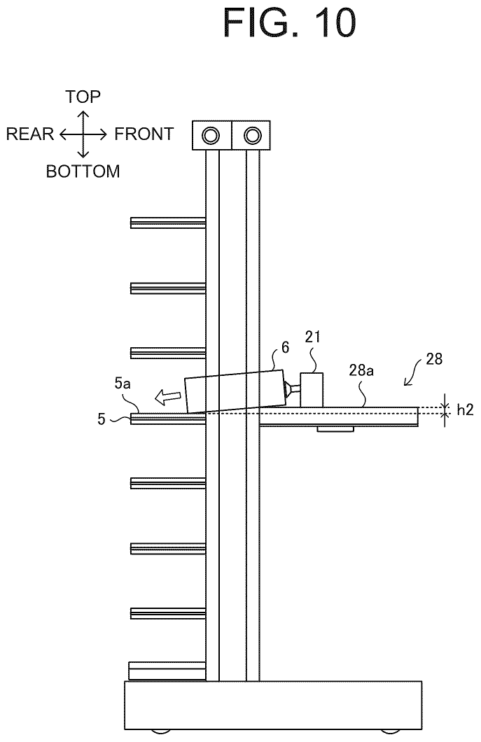

The automatic transport device 1 may further include a configuration capable of smoothly loading and unloading the object 6 to be transported. For example, FIG. 9 illustrates an example in which the object 6 to be transported is pulled out from the stock shelf 5 and placed on the slide surface 28a of the holder 28, and FIG. 10 illustrates an example in which the object 6 to be transported placed on the slide surface 28a is pushed into the stock shelf 5.

Specifically, the transfer device 2 is provided so as to be capable of being lifted and lowered in the automatic transport device 1, and when the object 6 to be transported stored in the storage (here, the stock shelf 5) is moved to the transfer device 2, as shown in FIG. 9, the transfer device 2 is lifted and lowered so that the slide surface 28a on which the object 6 to be transported is placed in the holder 28 is lower (the height h1 in FIG. 9) than a placement surface 5a on which the object 6 to be transported is placed in the stock shelf 5. Consequently, it is possible to prevent the object 6 to be transported from coming into contact with the transfer device 2 and being hindered from moving when the object 6 to be transported is pulled out from the stock shelf 5.

Further, in a case of moving the object 6 to be transported placed on the transfer device 2 onto the stock shelf 5, as shown in FIG. 10, the transfer device 2 is lifted and lowered so that the slide surface 28a on which the object 6 to be transported is placed in the holder 28 is higher (the height h2 in FIG. 10) than the placement surface 5a on which the object 6 to be transported is placed in the stock shelf 5. Consequently, it is possible to prevent the object 6 to be transported from coming into contact with the stock shelf 5 and being hindered from moving when pushing the object 6 to be transported out from the transfer device 2.

As another embodiment, the transfer device 2 may be lifted so that the slide surface 28a and the placement surface 5a are at the same height at the timing when an end portion on the side surface 6a side of the object 6 to be transported moves onto the slide surface 28a in FIG. 9. Similarly, the transfer device 2 may be lowered so that the slide surface 28a and the placement surface 5a are at the same height at the timing when an end portion (the side opposite to the side surface 6a) of the object 6 to be transported moves onto the placement surface 5a in FIG. 10. Consequently, a step between the slide surface 28a and the placement surface 5a can be eliminated, the object 6 to be transported can be moved more smoothly.

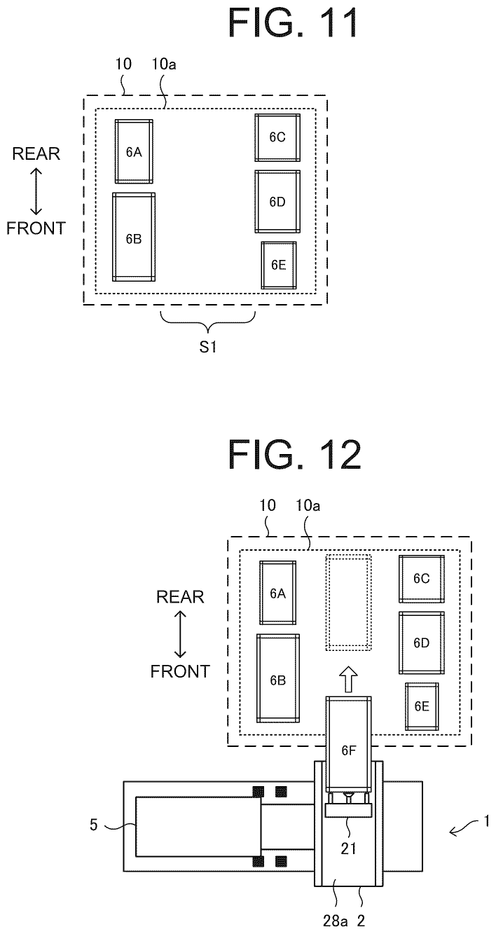

As another embodiment of the present disclosure, the automatic transport device 1 may control the movement amount of the binder 21 according to the size of the object 6 to be transported. FIG. 11 illustrates an example of the object 6 to be transported stored in the storage shelf 10. For example, a plurality of types of objects 6A to 6E to be transported with different sizes may be stored in the storage shelf 10. The symbol “10a” illustrated in FIG. 11 indicates a placement region on which the object 6 to be transported can be placed. As shown in FIG. 11, the object 6 to be transported may be arranged in the front-rear direction of the storage shelf 10. For example, the objects 6A and 6B to be transported are placed side by side in the front-rear direction in the placement region 10a, and the objects 6C, 6D, and 6E to be transported are placed side by side in the front-rear direction in the placement region 10a. A space S1 in which the object 6 to be transported can be placed exists between the objects 6A and 6B to be transported and the objects 6C, 6D, and 6E to be transported.

For example, in a case where the object 6F to be transported is stored in the storage shelf 10 according to a transport request, the transfer device 2 determines the movement amount (pushing amount) of the binder 21 according to the size (length in the front-rear direction) of the object 6F to be transported. For example, the transfer device 2 determines the movement amount of the binder 21 necessary for storing the object 6F to be transported in the storage shelf 10 on the basis of information (size, storage position, and the like) on the object 6F to be transported included in the transport request. Note that, each storage position in the storage shelf 10 and information (identification information, size, article name, and the like) on the stored object 6 to be transported may be associated in a database (not illustrated). In addition, information on each object 6 to be transported may be registered in the database.

For example, when the object 6F to be transported is stored on the rear side of the space S1 in the placement region 10a (see FIG. 12), the transfer device 2 calculates the movement amount up to the rear side of the space S1. Specifically, the transfer device 2 calculates the movement amount (pushing amount) of the binder 21 on the basis of the depth (length in the front-rear direction) of the placement region 10a and the length (length in the front-rear direction) of the object 6F to be transported. The transfer device 2 moves the binder 21 on the basis of the calculated movement amount, and places the object 6F to be transported in the space on the rear side of the placement region 10a.

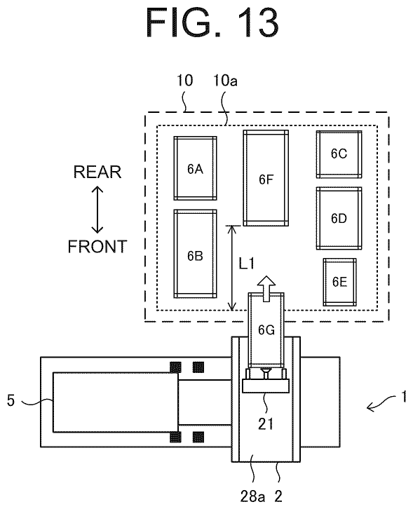

FIG. 13 shows an example of a case where the object 6F to be transported is stored on the rear side of the space S1 and the object 6G to be transported is stored on the front side of the space S1. In this case, the transfer device 2 determines the movement amount (pushing amount) of the binder 21 necessary for storing the object 6G to be transported in the space SI on the basis of the size of the object 6G to be transported and the size of the object 6F to be transported already stored in the same space S1. Specifically, the transfer device 2 calculates a distance L1 allowing for placement on the front side of the object 6F to be transported in the space S1, on the basis of the depth (length in the front-rear direction) of the placement region 10a and the length (length in the front-rear direction) of the object 6F to be transported, and calculates the movement amount (pushing amount) of the binder 21, on the basis of the distance L1 allowing for placement and the length of the object 6G to be transported. The transfer device 2 moves the binder 21 on the basis of the calculated movement amount to place the object 6F to be transported on the placement region 10a. Note that, when the distance L1 allowing for placement is shorter than the length of the object 6G to be transported, the transfer device 2 determines that the object 6G to be transported cannot be stored in the space S1, and searches for another space in which the object 6G to be transported can be stored.

As another embodiment, the transfer device 2 may include a camera or a sensor, acquire a storage state of the object 6 to be transported in the placement region 10a by the camera or the sensor, and determine whether or not the object 6 to be transported can be stored on the basis of the storage state. For example, in a case where a tag is provided on the side surface of the object 6F to be transported already stored in the storage shelf 10, when the camera or the sensor reads the tag, the transfer device 2 may acquire information (size, storage position, or the like) on the object 6F to be transported and determine whether the object 6G to be transported can be stored, on the basis of the acquired information.

When the object 6 to be transported stored in the storage shelf 10 is picked (pulled out), the transfer device 2 determines the movement amount of the binder 21 on the basis of the storage position of the object 6 to be transported placed in the placement region 10a and the size of the object 6 to be transported. The transfer device 2 moves the binder 21 by the movement amount and causes the binder 21 to adhere to the object 6 to be transported. As another embodiment, the transfer device 2 may move the binder 21 until the sucker 23 comes into contact with the side surface of the target 6 to be transported.

Although the automatic transport device 1 according to the present embodiment includes the stock shelf 5, as another embodiment, the automatic transport device 1 may not include the stock shelf 5. In this case, the automatic transport device 1 automatically travels to the target position in a state where the object 6 to be transported is held by the holder 28. Further, the automatic transport device 1 may be configured not to include the lifting and lowering device 4. In this case, in the automatic transport device 1, the transfer device 2 moves the binder 21 while being fixed to a predetermined height, thereby loading and unloading the object 6 to be transported. The automatic transport device 1 may not have a function to rotate the transfer device 2 about the rotation shaft 29. In this case, in the automatic transport device 1, the transfer device 2 loads and unloads the object 6 to be transported with respect to a specific direction.

In the above-described embodiment, the transfer device 2 includes the sucker 23 at the central portion of the main body frame 22 and includes the contact members 24a and 24b at the left and right sides of the sucker 23; however, as another embodiment, the transfer device 2 may include one contact member (or multiple contact members) 24 at the central portion of the main body frame 22 and may include the sucker 23 at each of the left and right sides of the contact member 24.

### Supplementary Notes of Disclosure

Hereinafter, an outline of the disclosure extracted from the above-described embodiments will be supplementarily noted. Note that the respective configurations and the respective processing functions described in the following supplementary notes can be selected and arbitrarily combined.

### Supplementary Note 1

An automatic transport device transporting an object to be transported to a predetermined location, the automatic transport device including:
a holder including a slide surface and slidably holding the object to be transported on the slide surface;
a binder binding to a side surface of the object to be transported, the binder including a sucker that adheres to a first position on the side surface of the object to be transported, and a contact member that abuts on a second position of the side surface;
a slide driver sliding the object to be transported on the slide surface in a state where the binder is binding to the side surface of the object to be transported; and
a driver enabling the automatic transport device to travel.

### Supplementary Note 2

The automatic transport device according to supplementary note 1, in which
the binder further includes a main body frame slid by the slide driver; and
the sucker and the contact member are provided so as to protrude from the main body frame.

### Supplementary Note 3

The automatic transport device according to supplementary note 2, in which
a protruding length of the sucker from the main body frame is longer than a protruding length of the contact member in a state before the sucker adheres to the object to be transported, and
the protruding length of the sucker becomes equal to the protruding length of the contact member in a state where the sucker adheres to the object to be transported, so that the contact member abuts on the side surface of the object to be transported.

### Supplementary Note 4

The automatic transport device according to supplementary note 2 or 3, in which
the sucker is provided so as to be movable in an axial direction of the sucker with respect to the main body frame upon receiving pressing force.

### Supplementary Note 5

The automatic transport device according to any of supplementary notes 1 to 4, in which
the contact member includes a first contact member and a second contact member,
the sucker adheres to a central portion of the side surface of the object to be transported, the first contact member abuts on a left side of the central portion of the side surface, and the second contact member abuts on a right side of the central portion of the side surface.

### Supplementary Note 6

The automatic transport device according to any of supplementary notes 1 to 5, in which
the binder is provided to be movable with respect to the slide surface in a first direction which is a protruding direction of the sucker and a second direction opposite to a first direction; and
the binder moves in the first direction which is a direction toward a storage in which the object to be transported is stored, and after the sucker adheres to the object to be transported in the storage, and after the contact member abuts on the object to be transported, the binder moves in the second direction together with the object to be transported, thereby placing the object to be transported on the slide surface.

### Supplementary Note 7

The automatic transport device according to any of supplementary notes 1 to 6, in which
the binder is provided to be movable with respect to the slide surface in the first direction which is the protruding direction of the sucker and the second direction opposite to the first direction, and
the binder moves in the first direction in a state where the sucker adheres to the object to be transported placed on the slide surface and where the contact member abuts on the object to be transported, thereby moving the object to be transported to a predetermined storage.

### Supplementary Note 8

The automatic transport device according to any of supplementary notes 1 to 7, including a first side wall and a second side wall provided at both ends of the slide surface in a direction orthogonal to a sliding direction, in which
the binder moves between the first side wall and the second side wall in a state where the object to be transported is adhered.

### Supplementary Note 9

The automatic transport device according to any of supplementary notes 1 to 8, in which a transfer device including the holder and the binder is provided so as to be capable of being lifted and lowered in the automatic transport device,
when the object to be transported stored in a storage is moved to the transfer device, the transfer device is lifted and lowered so that the slide surface on which the object to be transported is placed in the holder is lower than a placement surface on which the object to be transported is placed in the storage, and
when the object to be transported placed on the transfer device is moved to the storage, the transfer device is lifted and lowered so that the slide surface on which the object to be transported is placed in the holder is higher than the placement surface on which the object to be transported is placed in the storage.

### Supplementary Note 10

The automatic transport device according to supplementary note 9, in which
the storage is a stock shelf provided in the automatic transport device and is provided adjacent to the transfer device.

### Supplementary Note 11

The automatic transport device according to supplementary note 7, in which
a movement amount of the binder is determined based on a length of the object to be transported in the first direction.

### Supplementary Note 12

The automatic transport device according to supplementary note 7, in which
when another object to be transported is stored in a depth direction of the storage in which the object to be transported is to be stored, a movement amount of the binder is determined based on a length of the object to be transported in the first direction and a length of said another object to be transported in the first direction.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

What is claimed is:

1. An automatic transport device transporting an object to be transported to a predetermined location, the automatic transport device comprising:
a holder including a slide surface and slidably holding the object to be transported on the slide surface;
a binder binding to a side surface of the object to be transported, the binder including a sucker that adheres to a first position on the side surface of the object to be transported, and a contact member that abuts on a second position of the side surface;
a slide driver sliding the object to be transported on the slide surface in a state where the binder is binding to the side surface of the object to be transported; and
a driver enabling the automatic transport device to travel.

2. The automatic transport device according to claim 1, wherein
the binder further includes a main body frame slid by the slide driver; and
the sucker and the contact member are provided so as to protrude from the main body frame.

3. The automatic transport device according to claim 2, wherein
a protruding length of the sucker from the main body frame is longer than a protruding length of the contact member from the main body frame in a state before the sucker adheres to the object to be transported, and
the protruding length of the sucker becomes equal to the protruding length of the contact member in a state where the sucker adheres to the object to be transported, so that the contact member abuts on the side surface of the object to be transported.

4. The automatic transport device according to claim 2, wherein
the sucker is provided so as to be movable in an axial direction of the sucker with respect to the main body frame upon receiving pressing force.

5. The automatic transport device according to claim 1, wherein
the contact member includes a first contact member and a second contact member,
the sucker adheres to a central portion of the side surface of the object to be transported, the first contact member abuts on a left side of the central portion of the side surface, and the second contact member abuts on a right side of the central portion of the side surface.

6. The automatic transport device according to claim 1, wherein
the binder is provided to be movable with respect to the slide surface in a first direction which is a protruding direction of the sucker and a second direction opposite to the first direction, and
the binder moves in the first direction which is a direction toward a storage in which the object to be transported is stored, and after the sucker adheres to the object to be transported in the storage, and after the contact member abuts on the object to be transported, the binder moves in the second direction together with the object to be transported, thereby placing the object to be transported on the slide surface.

7. The automatic transport device according to claim 1, wherein
the binder is provided to be movable with respect to the slide surface in a first direction which is a protruding direction of the sucker and a second direction opposite to the first direction, and
the binder moves in the first direction in a state where the sucker adheres to the object to be transported placed on the slide surface and where the contact member abuts on the object to be transported, thereby moving the object to be transported to a predetermined storage.

8. The automatic transport device according to claim 1, comprising a first side wall and a second side wall provided at both ends of the slide surface in a direction orthogonal to a sliding direction, wherein
the binder moves between the first side wall and the second side wall in a state where the object to be transported is adhered.

9. The automatic transport device according to claim 1, wherein a transfer device including the holder and the binder is provided so as to be capable of being lifted and lowered in the automatic transport device,
when the object to be transported stored in a storage is moved to the transfer device, the transfer device is lifted and lowered so that the slide surface on which the object to be transported is placed in the holder is lower than a placement surface on which the object to be transported is placed in the storage, and
when the object to be transported placed on the transfer device is moved to the storage, the transfer device is lifted and lowered so that the slide surface on which the object to be transported is placed in the holder is higher than the placement surface on which the object to be transported is placed in the storage.

10. The automatic transport device according to claim 9, wherein
the storage is a stock shelf provided in the automatic transport device and is provided adjacent to the transfer device.

11. The automatic transport device according to claim 7, wherein
a movement amount of the binder is determined based on a length of the object to be transported in the first direction.

12. The automatic transport device according to claim 7, wherein
when another object to be transported is stored in a depth direction of the storage in which the object to be transported is to be stored, a movement amount of the binder is determined based on a length of the object to be transported in the first direction and a length of said another object to be transported in the first direction.
